(19) United States
(12) Patent Application Publication
(10) Pub. No.: US 2018/0128357 A1
(43) Pub. Date: May 10, 2018

(54) Articulating Sub-Housing For A Ball-Type Continuously Variable Planetary Transmission

(71) Applicant: Dana Limited, Maumee, OH (US)

(72) Inventor: Joseph S. VanSelous, Kapaa, HI (US)

(21) Appl. No.: 15/730,860

(22) Filed: Oct. 12, 2017

Related U.S. Application Data
(60) Provisional application No. 62/418,414, filed on Nov. 7, 2016.

(51) Int. Cl. F16H 15/50; F16H 57/08

(52) U.S. Cl. CPC F16H 15/503; F16H 57/082

(57) ABSTRACT

Provided herein is a continuously variable transmission (CVT) having a carrier assembly for a continuously variable transmission having a plurality of balls, each having a tiltable axis of rotation, a first traction ring assembly in contact with each ball, a second traction ring assembly in contact with each ball. The CVT is provided with a first sub-housing member coupled to a first carrier member. The first sub-housing member fixed from rotation and adapted to provide fluid containment of traction fluid for the CVT. The CVT is provided with a second sub-housing member coupled to a second carrier member. The second sub-housing member configured to rotate relative to the first sub-housing member corresponding to a shifting of the speed ratio of the CVT.

### RELATED APPLICATION

The present application claims the benefit of U.S. Provisional Application No. 62/418,414 filed on Nov. 7, 2016, which is incorporated herein by reference in its entirety.

### BACKGROUND

Automatic and manual transmissions are commonly used on automobiles. Such transmissions have become more and more complicated since the engine speed has to be adjusted to limit fuel consumption and the emissions of the vehicle. A vehicle having a driveline including a tilting ball variator allows an operator of the vehicle or a control system of the vehicle to vary a drive ratio in a stepless manner. A variator is an element of a Continuously Variable Transmission (CVT) or an Infinitely Variable Transmission (IVT). Transmissions that use a variator can decrease the transmission's gear ratio as engine speed increases. This keeps the engine within its optimal efficiency while gaining ground speed, or trading speed for torque during hill climbing, for example. Efficiency in this case can be fuel efficiency, decreasing fuel consumption and emissions output, or power efficiency, allowing the engine to produce its maximum power over a wide range of speeds. That is, the variator keeps the engine turning at constant speeds over a wide range of vehicle speeds.

Over time packaging of transmission components has become an ever increasing issue. As with most parts of a transmission, there is a desire to reduce weight, number and size of components to improve efficiency. For continuously variable transmission having variators operating with traction fluids, volume of operating fluid is a significant cost compared to the traditional automatic transmissions. Methods and configurations to reduce the volume of traction fluid while maintaining overall performance of the transmission are desired.

### SUMMARY

Provided herein is a continuously variable planetary (CVP) having a plurality of balls, each ball having a liftable axis of rotation, each ball in contact with a first traction ring and a second traction ring, the CVP having a rotatable shaft aligned along a longitudinal axis of the CVP, the rotatable shaft positioned radially inward of the balls, the first traction ring and the second traction ring; a carrier assembly operably coupled to each ball, the carrier assembly further includes a first carrier member arranged coaxial to the rotatable shaft and a second carrier member operably coupled to the first carrier member, configured to rotate relative to the first carrier member and arranged coaxial to the rotatable shaft; a first sub-housing member operably coupled to the first carrier member; and a second sub-housing member operably coupled to the second carrier member, wherein the second sub-housing member is adapted to rotate relative to the first sub-housing member, and wherein the first sub-housing member and the second sub-housing member enclose the plurality of balls, the first traction ring, the second traction ring, and the carrier assembly.

Provided herein is a housing for a continuously variable planetary (CVP) having a plurality of balls arranged radially about a rotatable shaft, each ball having a tiltable axis of rotation, each ball in contact with a first traction ring and a second traction ring, each ball supported in a carrier assembly having a first carrier member and a second carrier member, the housing having a first sub-housing member operably coupled to the first carrier member; and a second sub-housing member operably coupled to the second carrier member, wherein the second sub-housing member is adapted to rotate relative to the first sub-housing member, and wherein the first sub-housing member and the second sub-housing member enclose the plurality of balls, the first traction ring, the second traction ring, and the carrier assembly.

Provided herein is a continuously variable transmission (CVT) having a continuously variable planetary (CVP) provided with a plurality of balls, each ball having a tiltable axis of rotation, each ball in contact with a first traction ring and a second traction ring, the CVT having a rotatable shaft aligned along a longitudinal axis of the CVT, the rotatable shaft positioned radially inward of the balls, the first traction ring and the second traction ring; a multiple speed gearbox operably coupled to the CVP; a main transmission housing configured to enclose the multiple speed gearbox and the CVP, wherein the multiple speed gearbox is configured to operate with a first working fluid contained within the main transmission housing; a carrier assembly operably coupled to each ball, the carrier assembly having a first carrier member arranged coaxial to the rotatable shaft and a second carrier member operably coupled to the first carrier member, configured to rotate relative to the first carrier member and arranged coaxial to the rotatable shaft; a first sub-housing member operably coupled to the first carrier member; and a second sub-housing member operably coupled to the second carrier member, wherein the second sub-housing member is adapted to rotate relative to the first sub-housing member, wherein the first sub-housing member and the second sub-housing member enclose the plurality of balls, the first traction ring, the second traction ring, and the carrier assembly, and wherein the first sub-housing and the second sub-housing are configured to contain a second working fluid, wherein the CVP is configured to operate with the second working fluid.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a cross-sectional view of a ball-type variator having an articulating sub-housing.

FIG. 5 is a detail view A of a seal position on the articulating sub-housing of FIG. 4.

FIG. 6 is a detail view A of another seal position on the articulating sub-housing of FIG. 4.

FIG. 7 is a detail view A of yet another seal position on the articulating sub-housing of FIG. 4.

### DETAILED DESCRIPTION OF THE PREFERRED EMBODIMENTS

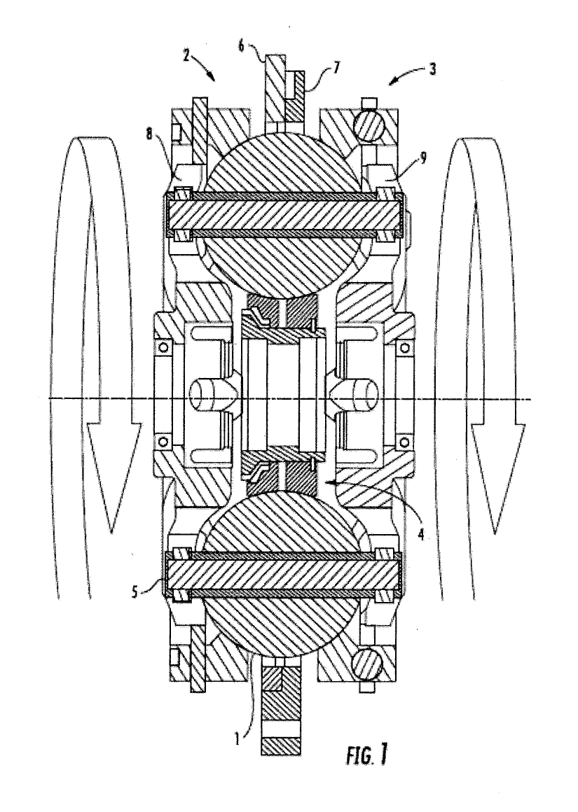

Provided herein are configurations of CVTs based on ball type variators, also known as CVP, for continuously variable planetary. Basic concepts of a ball type Continuously Variable Transmissions are described in U.S. Pat. No. 8,469,856 and U.S. Pat. No. 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls 1, as a first traction ring 2 and a second traction ring 3, and an idler (sun) assembly 4 as shown on FIG. 1. The balls 1 are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first carrier member and the second carrier member to impart a tilting of the axles 5 and thereby adjusts the speed ratio of the variator. Other types of ball CVTs also exist, like the one produced by Milner, but are slightly different.

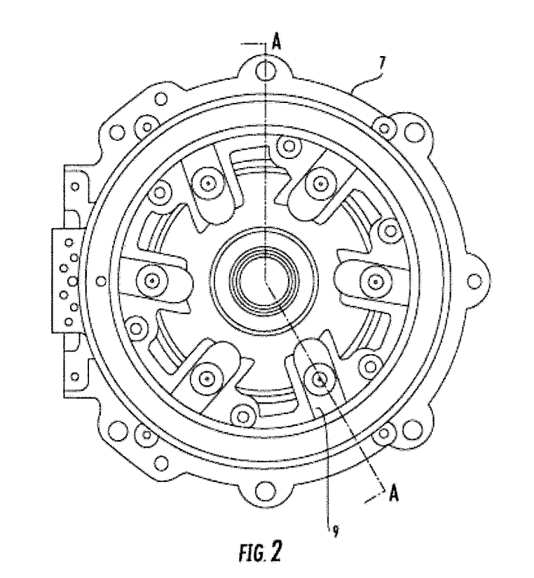

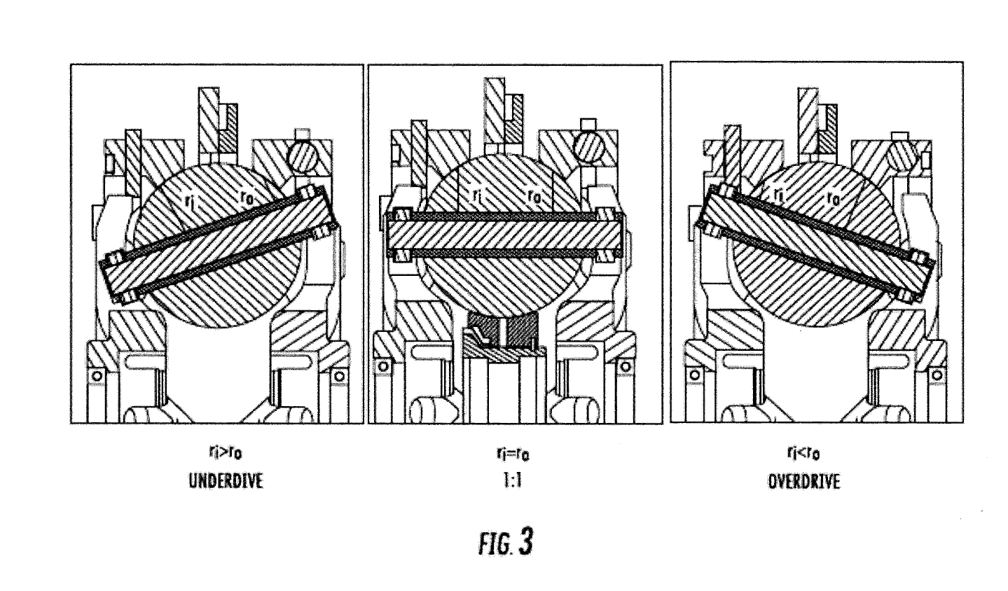

The working principle of such a CVP of FIG. 1 is shown on FIG. 2. The CVP itself works with a working fluid. In one embodiment, the working fluid is a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed herein are related to the control of a variator and/or a CVT using generally spherical planets each having a tiltable axis of rotation that is capable of being adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces which would be available at the interfaces of the contacting components and is a measure of the maximum available drive torque. In some embodiments, the traction coefficient is a design parameter in the range of 0.3 to 0.6. Typically, friction drives generally relate to transferring power between two elements by frictional forces between the elements. For the purposes of this disclosure, it should be understood that the CVTs described here may operate in both tractive and frictional applications. As a general matter, the traction coefficient ρ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”.

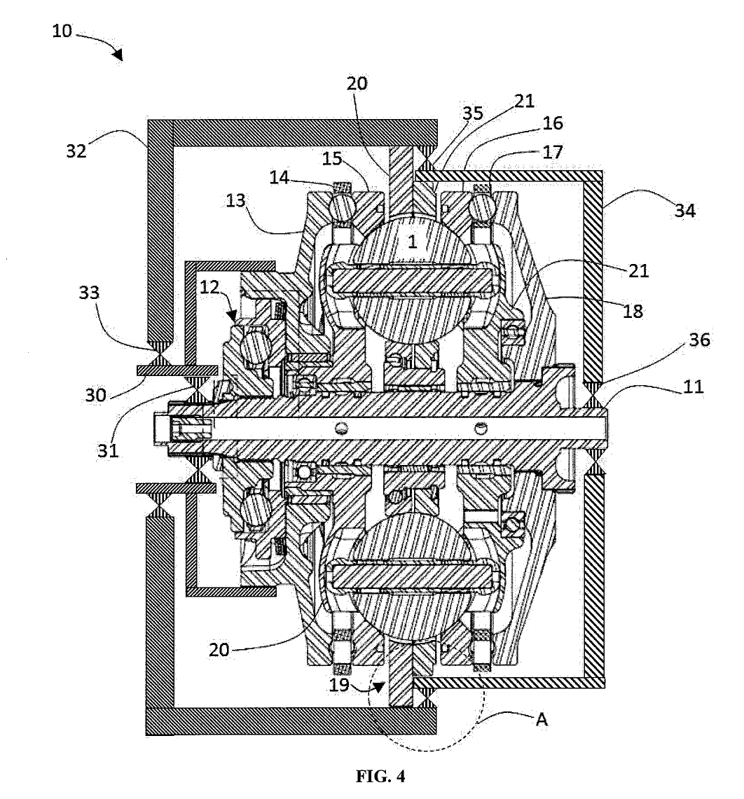

Referring now to FIG. 4, in some embodiments, a continuously variable planetary (CVP) 10 is provided with a shaft 11 that is arranged along the longitudinal axis. A thrust bearing assembly 12 is operably coupled to the shaft 11. In some embodiments, the CVP 10 is adapted to receive a rotational input power on a first cam driver 13. The first cam driver 13 is coupled to a first array of ball cam bearings 14. The first array of ball cam bearings 14 are configured to cooperate with a number ramped surfaces provided on the first cam driver 13 and/or a first traction ring 15 to provide torque dependent axial force, sometimes referred to as “clamping force”, “clamping”, or “axial clamp force”. The first traction ring 15 is in contact with a number of balls 1. In some embodiments, the CVP 10 is provided with a second traction ring 16 in contact with the balls 1. The second traction ring 16 is coupled to a second array of ball cam bearings 17. The ball cam bearings 17 are configured to cooperate with a number of ramped surfaces provided on the second traction ring 16 and/or a second cam driver 18. The second cam driver 18 is coupled to the shaft 11. In some embodiments, the second cam driver 18 is coupled to the shaft 11 with a set of splines. The shaft 11 is adapted to transmit a power output from the CVP 10. In some embodiments, the balls 1 are operably coupled to a carrier assembly 19. The carrier assembly 19 is provided with a first carrier member 20 and a second carrier member 21. The carrier assembly 19 is coaxial with the shaft 11. In some embodiments, the carrier assembly 19 is operably coupled to the shaft 11 with a bearing, a bushing, or some other means of rotatable coupling.

Still referring to FIG. 4, in some embodiments the CVP 10 is provided with an input coupling 30 configured to couple to the first cam driver 13. The input coupling 30 transmits rotational power to and/or from the first cam driver 13 during operation of the CVP 10. The input coupling 30 is coaxial with the shaft 11. The input coupling 30 is provided with a first shaft seal 31 coupled to the shaft 11. In some embodiments, the CVP 10 is provided with a first sub-housing member 32 coupled to the first carrier member 20. The first sub-housing member 32 operably couples to the input coupling 30 with a second shaft seal 33. The first sub-housing member 32 is configured to surround the internal components of the CVP 10. For example, the first sub-housing member 32 is a substantially bowl shaped body positioned to enclose the thrust bearing assembly 12, the first cam driver 13, and the first carrier member 20, among other components. In some embodiments, the first sub-housing member 32 is substantially fixed from rotation. The CVP 10 is provided with a second sub-housing member 34 operably coupled to the second carrier member 21. In some embodiments, a third shaft seal 35 is positioned between the second sub-housing member 34 and the first sub-housing member 32 to provide a fluid barrier between the interior of the second sub-housing member 34 and the exterior of the second sub-housing member 34.

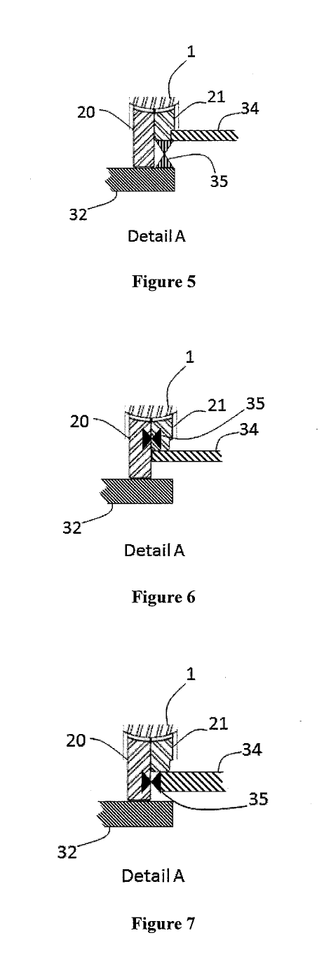

Referring to FIG. 5, in some embodiments, the third shaft seal 35 is arranged between the first sub-housing member 32 and the second carrier member 21 to provide a fluid barrier. Referring to FIG. 6, in some embodiments, the third shaft seal 35 is arranged between the second carrier member 21 and the first carrier member 20 to provide a fluid barrier. Referring to FIG. 7, in some embodiments, the third shaft seal 35 is arranged between the first carrier member 20 and the second sub-housing member 34 to provide a fluid barrier.

Referring back to FIG. 4, in some embodiments, the second sub-housing member 34 operably couples to the shaft 11 with a fourth shaft seal 36. The second sub-housing member 34 is configured to enclose a portion of the components of the CVP 10. For example, the second sub-housing member 34 is a substantially bowl shaped body positioned to surround the second cam driver 18 and the second carrier member 21, among other components of the CVP 10. In some embodiments, the second carrier member 21 is adapted to rotate with respect to the first carrier member 20 to thereby change the operating speed ratio of the CVP 10. The second sub-housing member 34 is fixedly coupled to the second carrier member 21. A rotation of the second carrier member 21 corresponds to a rotation of the second sub-housing member 34 and vice versa. In some embodiments, a shift actuator (not shown) is a device configured to impart a relative rotation of the second sub-housing member 34 to the first sub-housing member 32 to thereby impart a change in operating speed ratio of the CVP. It should be appreciated that the first shaft seal 31, the second shaft seal 33, the third shaft seal 35, and the fourth shaft seal 36 are well known components for provided a sealed interface between components.

During operation of the CVP 10, the first sub-housing member 32 and the second sub-housing member 34 provide fluid containment around the internal components of the CVP 10. Therefore, the traction fluid used in the device is contained within a known volume and perimeter. In some embodiments, a fluid pump is provided to circulate pressurized fluid in and out of the enclosure of the first sub-housing member 32 and the second sub-housing member 34. It should be appreciated that the CVP 10 is optionally configured in transmissions having a multiple speed gearbox. In some embodiments, a multiple speed gearbox includes multiple clutches coupled to fixed gear ratios, such as the configurations disclosed in U.S. Patent Application 62/343,297, which is incorporated herein by reference in their entirety. Other types of transmissions, such as toroidal-type transmissions have incorporated enclosures to separate fluid within a continuously variable transmission. For example, U.S. Pat. No. 6,705,964, which is incorporated herein by reference in their entirety, discloses a fixed sub-housing surrounding a toroidal-type transmission to contain a smaller volume of traction fluid for use inside of the continuously variable transmission assembly. The multiple speed gearbox is configured to operate with a working fluid including, but not limited to, an automatic transmission fluid. The automatic transmission fluid can be contained in a main transmission housing configured to enclose the multiple speed gearbox.

The foregoing description details certain embodiments. It will be appreciated, however, that no matter how detailed the foregoing appears in text, the embodiments can be practiced in many ways. As is also stated above, it should be noted that the use of particular terminology when describing certain features or aspects of the preferred embodiments should not be taken to imply that the terminology is being re-defined herein to be restricted to including any specific characteristics of the features or aspects of the preferred embodiments with which that terminology is associated.

While preferred embodiments of the present preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments of the preferred embodiments described herein may be employed in practicing the preferred embodiments. It is intended that the following claims define the scope of the preferred embodiments and that methods and structures within the scope of these claims and their equivalents be covered thereby.

What is claimed is:

1. A continuously variable planetary (CVP) having a plurality of balls, each ball having a tiltable axis of rotation, each ball in contact with a first traction ring and a second traction ring, the CVP comprising:
a rotatable shaft aligned along a longitudinal axis of the CVP, the rotatable shaft positioned radially inward of the balls, the first traction ring and the second traction ring;
a carrier assembly operably coupled to each ball, the carrier assembly comprising:
a first carrier member arranged coaxial to the rotatable shaft, and
a second carrier member operably coupled to the first carrier member, the second carrier member configured to rotate relative to the first carrier member and arranged coaxial to the rotatable shaft;
a first sub-housing member operably coupled to the first carrier member; and
a second sub-housing member operably coupled to the second carrier member,
wherein the second sub-housing member is adapted to rotate relative to the first sub-housing member, and
wherein the first sub-housing member and the second sub-housing member enclose the plurality of balls, the first traction ring, the second traction ring, and the carrier assembly.

2. The CVP of claim 1, wherein the first sub-housing member is non-rotatable.

3. The CVP of claim 2, further comprising a first shaft seal arranged between the rotatable shaft and the first sub-housing member.

4. The CVP of claim 1, wherein the second sub-housing member and the second carrier member rotate in unison with respect to the first sub-housing member and the first carrier member.

5. The CVP of claim 1, wherein the first sub-housing member is a bowl-shaped body arranged to surround the first carrier member.

6. The CVP of claim 5, wherein the second sub-housing member is a bowl-shaped body arranged surround the second carrier member.

7. A housing for a continuously variable planetary (CVP) having a plurality of balls arranged radially about a rotatable shaft, each ball having a tiltable axis of rotation, each ball in contact with a first traction ring and a second traction ring, each ball supported in a carrier assembly having a first carrier member and a second carrier member, the housing comprising:
a first sub-housing member operably coupled to the first carrier member; and
a second sub-housing member operably coupled to the second carrier member,
wherein the second sub-housing member is adapted to rotate relative to the first sub-housing member, and wherein the first sub-housing member and the second sub-housing member enclose the plurality of balls, the first traction ring, the second traction ring, and the carrier assembly.

8. The housing of claim 7, wherein the first sub-housing member is non-rotatable.

9. The housing of claim 8, further comprising a first shaft seal arranged between the rotatable shaft and the first sub-housing member.

10. The housing of claim 7, wherein the second sub-housing member and the second carrier member rotate in unison with respect to the first sub-housing member and the first carrier member.

11. The housing of claim 7, wherein the first sub-housing member is a bowl-shaped body arranged to surround the first carrier member.

12. The housing of claim 11, wherein the second sub-housing member is a bowl-shaped body arranged surround the second carrier member.

13. A continuously variable transmission (CVT) having a continuously variable planetary (CVP) provided with a plurality of balls, each ball having a tiltable axis of rotation, each ball in contact with a first traction ring and a second traction ring, the CVT comprising:
a rotatable shaft aligned along a longitudinal axis of the CVT, the rotatable shaft positioned radially inward of the balls, the first traction ring and the second traction ring;
a multiple speed gearbox operably coupled to the CVP;
a main transmission housing configured to enclose the multiple speed gearbox and the CVP, wherein the multiple speed gearbox is configured to operate with a first working fluid contained within the main transmission housing;
a carrier assembly operably coupled to each ball, the carrier assembly comprising:
a first carrier member arranged coaxial to the rotatable shaft, and
a second carrier member operably coupled to the first carrier member, the second carrier member configured to rotate relative to the first carrier member and arranged coaxial to the rotatable shaft;
a first sub-housing member operably coupled to the first carrier member; and
a second sub-housing member operably coupled to the second carrier member;
wherein the second sub-housing member is adapted to rotate relative to the first sub-housing member,
wherein the first sub-housing member and the second sub-housing member enclose the plurality of balls, the first traction ring, the second traction ring, and the carrier assembly, and
wherein the first sub-housing and the second sub-housing are configured to contain a second working fluid, wherein the CVP is configured to operate with the second working fluid.

14. The CVT of claim 13, wherein the first sub-housing member is non-rotatable.

15. The CVT of claim 14, further comprising a first shaft seal arranged between the rotatable shaft and the first sub-housing member.

16. The CVT of claim 13, wherein the second sub-housing member and the second carrier member rotate in unison with respect to the first sub-housing member and the first carrier member.

17. The CVT of claim 13, wherein the first sub-housing member is a bowl-shaped body arranged to surround the first carrier member.

18. The CVT of claim 17, wherein the second sub-housing member is a bowl-shaped body arranged surround the second carrier member.

19. The CVT of claim 13, wherein the first working fluid is an automatic transmission fluid.

20. The CVT of claim 13, wherein the second working fluid is a traction fluid.
